(19) United States
(12) Patent Application Publication
(10) Pub. No.: US 2012/0177787 A1
(43) Pub. Date: Jul. 12, 2012

(54) METHOD FOR PRODUCING FROZEN ROLLED FOOD

(75) Inventors: Hiroshi MIZUNO, Gunma (JP); Shuhei Oka, Gunma (JP); Masashi Sekine, Gunma (JP); Tatsuya Yamamoto, Gunma (JP)

(73) Assignee: AJINOMOTO CO. INC, Tokyo (JP)

(21) Appl. No.: 13/349,066

(22) Filed: Jan. 12, 2012

Related U.S. Application Data
(63) Continuation of application No. PCT/JP10/62031, filed on Jul. 12, 2010.

(30) Foreign Application Priority Data
Jul. 13, 2009 (JP) 2009/164922

(51) Int. Cl. A23L 1/33; A23B 4/06; A23L 1/212; A23L 1/322; A23L 1/36

(52) U.S. Cl. 426/92; 426/531; 426/643; 426/614; 426/629; 426/615; 426/100

(57) ABSTRACT

Frozen rolled foods, such as a sushi roll, that can be frozen in a favorable state and taste good after thawing may be prepared by: cooking and seasoning one or more food items such as rolled egg, freeze-dried bean curd, shiitake mushroom, minced and steamed fish meat, and dried gourd shavings; aligning the food, to form a core; freezing the core using a cryogen, to form a frozen core; spreading a thin sheet of sushimeshi over a support such as a bamboo mat or a wrapping film; overlaying a dried laver sheet on the sushimeshi; placing the frozen core on the dried laver sheet while in the frozen state; wrapping the sushimeshi and the dried laver sheet around the core held at the center to form a sushi roll; and rapidly freezing the sushi roll at −50° C. or less to obtain a frozen sushi roll.

### CROSS REFERENCES TO RELATED APPLICATIONS

This application is a continuation of International Patent Application No. PCT/JP2010/062031, filed on Jul. 12, 2010, and claims priority to Japanese Patent Application No. 164922/2009, filed on Jul. 13, 2009, both of which are incorporated herein by reference in their entireties.

### BACKGROUND OF THE INVENTION

1. Field of the Invention

The present invention relates to method for producing a rolled food, such as a sushi roll and rolled cakes, in a frozen state from a rolled food obtained by wrapping a food sheet around a core.

2. Discussion of the Background

As one method of producing rolled foods such as sushi rolls and rolled cakes, a method is available in which ingredients forming a stick-shaped core are frozen, and a sheet of food, or a food sheet, is wrapped around the frozen core to uniformly produce rolled food in large quantity (see, for example, which is incorporated herein by reference in its entirety).

There is a demand for rolled foods, such as sushi rolls and rolled cakes, that can be preserved in a frozen state, in recent years. For example, rolled foods that use cooked rice as in sushi rolls require rapid freezing at −100° C. or less, because slow freezing such as in a freezer degrades the cooked rice. However, rapid freezing of a formed sushi roll often creates a difference in expansion rate because of the temperature difference between the central portion and the peripheries, and tends to cause cracking on the surface, with the result that the commodity value is lost. The method of JP-A-6-237717 involves such degradation of cooked rice when the food is frozen in a freezer, and thus causes a significant loss in the texture.

Thus, there remains a need for improved methods for preparing rolled foods, especially in the frozen state.

### SUMMARY OF THE INVENTION

Accordingly, it is one object of the present invention to provide novel methods for producing frozen rolled foods.

It is another object of the present invention to provide novel methods for producing frozen rolled foods, whereby the rolled food can be frozen in a favorable state and can provide good quality upon thawing.

It is another object to provide frozen rolled foods prepared by such a process.

These and other objects, which will become apparent during the following detailed description, have been achieved by the inventors' discovery that a method for producing frozen rolled food through freezing of a rolled food obtained by wrapping a food sheet around a core, the method including freezing the core and wrapping the food sheet around the core to form a rolled food, and freezing the rolled food with a cryogen of −50° C. or less provides excellent frozen rolled foods. The rolled food may be a sushi roll.

The method for producing a frozen rolled food according to the present invention comprises forming the food by wrapping a food sheet around a core frozen in advance, and rapidly freezing the food by directly dipping it in a ultralow-temperature cryogen of −50° C. or less before the core temperature increases. In this way, the difference in the expansion rate between the peripheries and the central portion of the formed product can be made smaller to prevent cracking. Further, because the food is rapidly frozen, it is possible to suppress degradation of cooked rice, which is susceptible to degradation, and to provide a frozen rolled food that is cosmetically appealing and has a good texture upon being thawed for consumption. Further, the rapid freezing can prevent degradation even for food that contains a food sheet susceptible to degradation, and can thus provide a frozen rolled food, for example, a frozen sushi roll, that provides good quality upon thawing.

### BRIEF DESCRIPTION OF THE DRAWINGS

A more complete appreciation of the invention and many of the attendant advantages thereof will be readily obtained as the same become better understood by reference to the following detailed description when considered in connection with the accompanying drawings, wherein:

FIG. 1 is a front view of a frozen sushi roll representing an embodiment of the present invention.

FIG. 2 is a cross sectional view of the frozen sushi roll.

FIG. 3 is a front view of a frozen sushi roll of Example 1 frozen with liquid nitrogen.

FIG. 4 is a graph representing a freeze curve of a frozen sushi roll produced under varying freezing conditions in Example 2.

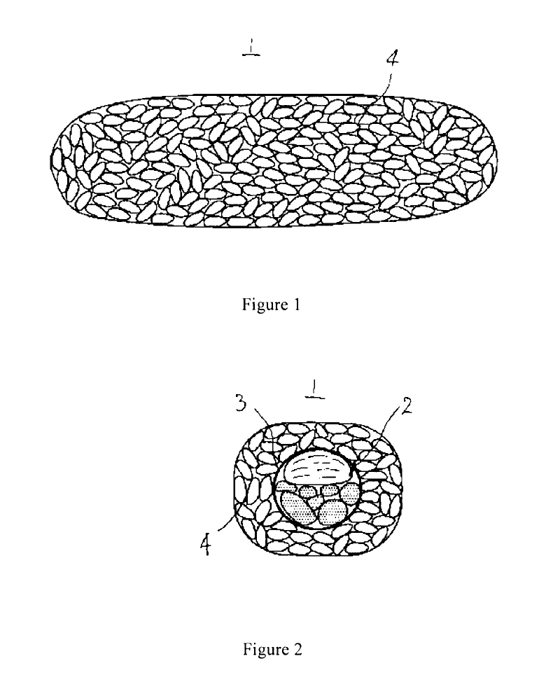

### DESCRIPTION OF REFERENCE NUMERALS AND SIGNS

In the figures, the reference numerals have the following meanings:

1 Frozen sushi roll

2 Core

3 Dried laver sheet

4 Sushimeshi (vinegar-seasoned rice)

5 Crack

### DETAILED DESCRIPTION OF THE PREFERRED EMBODIMENTS

FIG. 1 represents an embodiment of the present invention applied to a frozen sushi roll. A frozen sushi roll 1 includes a stick-shaped core 2 formed by appropriately cooking and seasoning the ingredients, and a dried laver sheet 3 and a thin sheet of sushimeshi 4 wrapped around the core 2.

The term laver sheet refers to sheet made from various edible seaweed species of the red alga, Porphyra, including most notably P. yezoensis and P. tenera, and is sometimes referred to as Nori.

The core 2 is obtained by appropriately cooking and seasoning food items, for example, such as rolled egg, koya-dofu (freeze-dried bean curd), shiitake mushroom, shrimp, and kanpyo (dried gourd shavings). These food items are aligned in a predetermined length and individually frozen using a cryogen such as dry ice and ethanol.

The method, temperature, and time used for freezing the core are not particularly limited so long as they are able to produce a frozen core. One of skill in the art can choose a suitable method and conditions depending on the thickness and identity of the food items used in the core. The core is typically frozen to a temperature less than −18° C., although lower temperatures may be preferred.

Then, a thin sheet of sushimeshi 4 is spread over a bamboo mat or a wrapping film, and the dried laver sheet 3 is overlaid on the sushimeshi 4. The core 2 is then placed on the dried laver sheet 3 in the frozen state. The sushimeshi 4 and the dried laver sheet 3 are wrapped around the core 2 held at the center to form a sushi roll. The sushi roll is then rapidly frozen by being directly dipped in a cryogen of −50° C. or less, for example, −70° C. dry ice/ethanol or −196° C. liquid nitrogen, while maintaining the core 2 in the low-temperature frozen state. As a result, the frozen sushi roll 1 is obtained.

In more detail, the preferred conditions for freezing the rolled food may change depending on the thickness of the rolled food (sushi). For example, in the case of a rolled sushi having a diameter of about 5 cm, the times and final temperatures for various cryogens are shown in the table below.

| Cryogen | Preferred Time | Preferred Final Temperature |
|---|---|---|
| Liquid Nitrogen | 5 to 10 minutes | −18° C. to −30° C. |
| Dry Ice/Ethanol | 7 to 15 minutes | −18° C. to −30° C. |
| Dry Ice | 40 to 70 minutes | −18° C. to −30° C. |

Of course, one of skill in the art would understand how to adjust these conditions for rolled foods of different dimensions and compositions.

Suitable dimensions for a rolled sushi prepared according to the present invention are shown in the following table.

| | Thickness | Length | Diameter | Width |
|---|---|---|---|---|
| Core | — | 30 to 300 mm | 5 to 60 mm | — |
| Dried | 0.05 to 0.5 mm | 30 to 300 mm | — | 30 to 300 mm |
| Laver | | | | |
| Sheet | | | | |
| Rolled | — | 30 to 300 mm | 10 to 80 mm | — |
| Sushi | | | | |

Of course, dimensions outside these ranges may also be used.

In this manner, the frozen sushi roll 1 is produced with the core 2 frozen in advance, and as such the rapid freezing of the roll of the dried laver sheet 3 and the sushimeshi 4 around the core 2 is unlikely to create a difference in the expansion rate between the peripheries and the central portion of the frozen sushi roll 1. There accordingly will be no cracking on the surface, and the frozen sushi roll 1 is cosmetically appealing. Further, because the sushimeshi 4, susceptible to degradation, is rapidly frozen, degradation can be suppressed, and the frozen sushi roll 1 can provide good taste upon thawing. Further, because the sushimeshi 4 is wrapped around the core 2 while the core 2 is in the frozen state, the forming procedure is easy, and deformation is unlikely to occur. Further, because the core 2 is frozen and the shape remains stable, and does not move around when wrapping the sushimeshi or dried laver sheet, the shape and the combination of the core 2 can be varied to desirably decorate the sushi roll with a flower or an animal pattern on the cross section.

The final frozen rolled food (sushi) is typically stored at a temperature below −18° C. prior to thawing for consumption. Lower storage temperatures may be preferred. In addition, it is preferred that the storage temperature does not vary.

Note that the present invention is not limited to the foregoing embodiment, and the dried laver sheet may be wrapped around the outer side of the sushimeshi. Further, the invention is also applicable to hosomaki, obtained by wrapping sushimeshi around a core that includes only one ingredient. Aside from sushi rolls, the invention is also applicable to, for example, rolled cake that includes a fruit or a cream core, and a sheet-like sponge cake wrapped around the core.

Other features of the invention will become apparent in the course of the following descriptions of exemplary embodiments which are given for illustration of the invention and are not intended to be limiting thereof.

### EXAMPLES

### Example 1

The dried laver sheet 3 and sushimeshi 4 were wrapped around the core 2 of the frozen sushi roll of the foregoing embodiment without freezing the core 2 in advance, and sushi rolls (here and below, futomaki, 5 cm in diameter) were obtained. The sushi rolls were frozen with liquid nitrogen (−196° C.), dry ice/ethanol (−70° C.), and air blast (−30° C.), and the extent of surface cracking was compared. The results are presented in Table 1.

TABLE 1

| Cryogen | Occurrence of cracking | |
|---|---|---|
| Liquid nitrogen | Poor | Very noticeable; tend to remain even |
| | | after thawing |
| Dry ice/ethanol | Acceptable | Present; almost unnoticeable after |
| | | thawing |
| Air blast | Good | Absent |

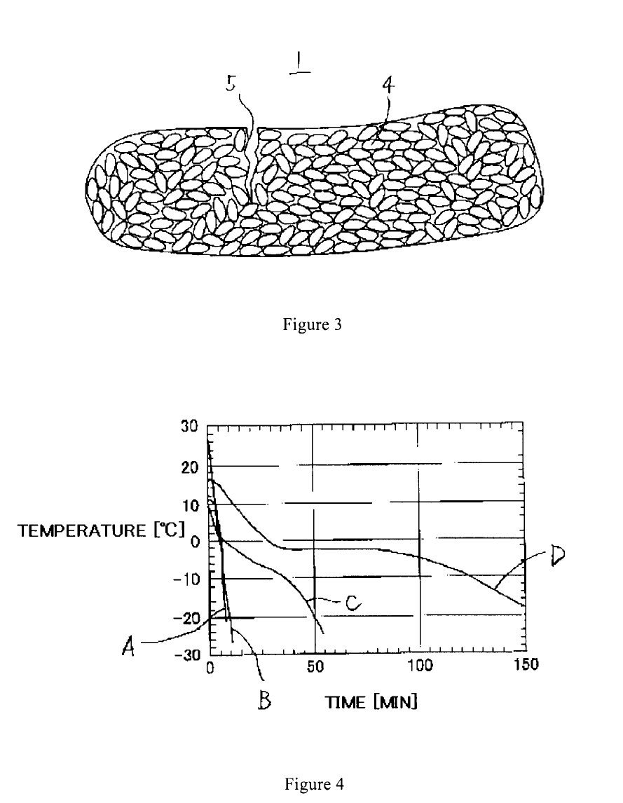

It can be seen from the results presented in Table 1 that surface cracking easily occurs by low-temperature rapid freezing, particularly in samples frozen with the liquid nitrogen, as demonstrated by the generation of a crack 5 on the surface of the sushimeshi 4 (FIG. 3). Further, the frozen sushi roll had a bad appearance with a distorted center.

### Example 2

Sushi rolls were produced without freezing the core 2 in advance, and were frozen using liquid nitrogen (A), dry ice/ethanol (B), dry ice (C), and a laboratory freezer (D). A freeze curve for the central portion is represented in FIG. 4.

As can be seen in FIG. 4, freezing with liquid nitrogen (A) and dry ice/ethanol (B) quickly passed the zone of maximum ice crystal formation, whereas the passage through the zone of maximum ice crystal formation was slow with dry ice (C) and in a laboratory freezer (D). It can be seen that freezing with liquid nitrogen (A) most quickly passes the zone of maximum ice crystal formation.

### Example 3

The dried laver sheet 3 and sushimeshi 4 were wrapped around the core 2 which was frozen in advance, and the resulting rolls were frozen with liquid nitrogen, dry ice/ethanol, and air blast. The sushi rolls were then transferred from a freezer to a refrigerator, where the sushi was thawed and, and preserved for a predetermined time period. Each sushi roll was tested by sensory evaluation. The results are presented in Table 2.

TABLE 2

| | Preservation time in refrigerator | | |
|---|---|---|---|
| Cryogen | 24 hours | 35 hours | 47 hours |
| Liquid nitrogen | 5 | 4 | 3 |
| Dry ice/ethanol | 4 | 3 | 3 |
| Air blast | 3 | 2 | 2 |

5: Excellent, 4: Good, 3: Acceptable, 2: Poor, 1: Very poor

It can be seen from the results presented in Table 2 that the rapid freezing at ultralow temperature produces better quality for food preserved in a refrigerator after being thawed. The difference was particularly notable in the texture of the sushimeshi, with the faster freezing rates eliminating the feel of roughness and no-stickiness due to the degradation (retrogradation) of the sushimeshi. The result was most desirable when liquid nitrogen was used. Further, because the core 2 was frozen in advance, the rapid freezing of the formed sushi roll with the liquid nitrogen did not cause surface cracking, and the sushi roll had a desirable appearance.

### Example 4

The dried laver sheet 3 and sushimeshi 4 were wrapped around the core 2 which was frozen in advance, and the resulting rolls were frozen with liquid nitrogen, dry ice/ethanol, and air blast. The sushi rolls were then transferred from a freezer to a refrigerator. After 24 hours, the physical properties of the sushi rolls thawed in the refrigerator were measured using a texture analyzer. The results are presented in Table 3.

TABLE 3

| | | Surface | | Whole | | |
|---|---|---|---|---|---|---|
| | | Hardness | Stickiness | Hardness | Stickiness | |
| Cryogen | | (g) | (g) | (g) | (g) | Remarks |
| 0-Hour refrigeration | | 118.3 | 2.9 | 1619.7 | 22.8 | |
| 24-Hour refrigeration | Liquid nitrogen | 143.2 | 1.0 | 2228.6 | 14.6 | Soft |
| | Dry ice/ethanol | 210.7 | 0.9 | 2357.3 | 16.9 | ↑ |
| | Air blast | 270.5 | 1.0 | 2486.0 | 12.4 | Hard |

As can be seen from the results presented in Table 3, the sushi rolls rapidly frozen at ultralow temperature maintained softness even after thawing, and the rate of hardening due to starch degradation was slow in these sushi rolls. The texture was thus desirable.

It can be seen from these experiment results that the use of the frozen core and the rapid freezing of the formed sushi roll at ultralow temperature with liquid nitrogen or dry ice/ethanol can produce a frozen sushi roll that has a good appearance and a desirable texture for consumption, particularly when the food is rapidly frozen by being dipped in liquid nitrogen.

Note that the cryogen temperature for freezing varies depending on such factors as the diameter of the sushi roll or other rolled food, or the type of material used. For typical hosomaki, a temperature around −50° C. is sufficient. For futomaki, the cryogen temperature is preferably −100° C. or less.

Where a numerical limit or range is stated herein, the endpoints are included. Also, all values and subranges within a numerical limit or range are specifically included as if explicitly written out.

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

1. A method for producing a frozen rolled food, comprising:
freezing a food core, to obtain a frozen food core;
wrapping a food sheet around said frozen core, to obtain a rolled food; and
freezing said rolled food with a cryogen at a temperature of −50° C. or less.

2. A method according to claim 1, wherein said rolled food is a sushi roll.

3. A method according to claim 1, wherein said core comprises one or more ingredients selected from the group consisting of rolled egg, freeze-dried bean curd, shiitake mushroom, shrimp, and dried gourd shavings.

4. A method according to claim 1, wherein said cryogen is liquid nitrogen or a dry ice/ethanol mixture.

5. A method according to claim 1, which comprises:
aligning one or more food items, to obtain a core;
freezing said core, to obtain a frozen core;
forming a layer of sushimeshi;
placing a dried laver sheet on said layer of sushimeshi;
placing said frozen core on said dried laver sheet;
wrapping said sushimeshi and said dried laver sheet around said frozen core, to obtain a sushi roll; and
freezing said sushi roll with a cryogen at a temperature of −50° C. or less, to obtain said frozen rolled food.

6. A frozen rolled food, which is prepared by a process according to claim 1.

7. A frozen rolled food, which is prepared by a process according to claim 2.

8. A frozen rolled food, which is prepared by a process according to claim 3.

9. A frozen rolled food, which is prepared by a process according to claim 4.

10. A frozen rolled food, which is prepared by a process according to claim 5.
